(19) United States
(12) Patent Application Publication
(10) Pub. No.: US 2010/0243617 A1
(43) Pub. Date: Sep. 30, 2010

(54) PRINTED CIRCUIT BOARD VIA DRILLING STAGE ASSEMBLY

(75) Inventor: Mark T. Kosmowski, Beaverton, OR (US)

Correspondence Address: ELECTRO SCIENTIFIC INDUSTRIES/STOEL RIVES, LLP, 900 SW FIFTH AVE., SUITE 2600, PORTLAND, OR, 97204-1268, US

(73) Assignee: Electro Scientific Industries, Inc., Portland, OR (US)

(21) Appl. No.: 12/412,130

(22) Filed: Mar. 26, 2009

(51) Int. Cl. B23K 26/38; B23B 35/00; B23B 39/06

(52) U.S. Cl. 219/121.7; 408/1 R; 408/13

(57) ABSTRACT

A via drilling system is preferably constructed to process one target at a time. The via drilling system preferably provides a relatively small footprint for the via drilling system, relatively small moment arms between via drilling system components, a relatively short stiffness loop, and a relatively fast processing time for a target. Multiple tools are preferably provided to perform multiple operations substantially simultaneously on the target.

### COPYRIGHT NOTICE

© 2009 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

The present disclosure relates to target processing systems, and in particular, to stage architectures for creating vias in printed circuit boards and other targets.

### BACKGROUND INFORMATION

Printed circuit board (“PCB”) and flex circuit panel via drilling systems are typically configured with a multiple stage architecture and with multiple drilling tools to simultaneously process multiple panels. Common stage architectures include a first stage for holding one or both of PCBs and flex circuit panels in a side-by-side arrangement, which commonly requires a relatively large area of floor space. The first stage commonly moves along one axis of a Cartesian coordinate system and is substantially constrained from moving in the remaining two degrees of linear motion and in the three degrees of rotational motion.

A second stage is commonly included in current via drilling systems for carrying the via drilling tools and for moving the tools along a second axis of the Cartesian coordinate system. The second axis is orthogonal and plane parallel to the first axis. Current second stages are commonly designed to hold multiple tools that may be ganged together to impart a common motion to the ganged tools so that each tool performs a nearly identical via drilling operation on nearly identical sections of different PCBs and flex circuit panels. A mechanism is commonly provided for moving each of the tools along the third axis of the Cartesian coordinate system that is orthogonal to both the first and second axes. Examples of current stage architectures for via drilling systems are described in U.S. Pat. Nos. 6,325,576 and 7,198,438, both assigned to Electro Scientific Industries, Inc., the assignee of this patent application.

The present inventor has recognized certain disadvantages associated with current via drilling systems. One disadvantage is that the size of current via drilling systems commonly requires a relatively large area of floor space because of the side-by-side arrangement of the panels. Floor space is commonly at a premium in clean environments, where via drilling systems are typically used. Another disadvantage is that current arrangements of the stages that accommodate side-by-side panels create systems with relatively long moment arms and thus a relatively soft stiffness loop. Soft stiffness loops may have natural frequencies that limit how fast the various stages may be driven. Another disadvantage is that a side-by-side arrangement for multiple panels is a relatively inefficient manner to process multiple panels from a system throughput viewpoint, especially when floor space is considered.

### SUMMARY OF THE DISCLOSURE

A preferred via drilling system includes a lower base structure and an upper base structure having a tunnel therethrough. Preferably, one target at a time is processed. The target preferably contains multiple work pieces, and each work piece includes one or more locations to be drilled. A panel stage attached to the lower base structure moves the target through the tunnel. Tool stages attached to the upper base structure carry drilling tools, where the tool stages move the drilling tools orthogonally to the direction the panel stage moves. The drilling tools preferably perform drilling operations on the target through slots in the upper base structure where the slots open to the tunnel. The slots are orthogonal to the direction the target moves. For example, two tool stages are preferably mounted over a first slot, and two tool stages are preferably mounted over a second slot.

As the target moves through the tunnel, the tools perform drilling operations through the slots. For example, each tool stage may move each tool synchronously to perform identical drilling operations at the same time, on the same work piece, or on different work pieces. Alternatively, two tool stages may move a first tool and a second tool synchronously to perform identical drilling operations at the same time on a first work piece and a second work piece. At the same time, the remaining two tool stages may move the third tool and the fourth tools synchronously to perform second identical drilling operations, different from the first identical drilling operations, where the first and third tools drill in the first work piece and the second and fourth tool drill in the second work piece. Alternatively, the tool stages may move the tools independently of one another to perform different drilling operations at the same time in the same work piece, or in different work pieces.

A preferred via drilling system embodiment includes a dimensionally stable upper base attached, or mechanically coupled, to a dimensionally stable lower base, in which the bases are made from granite, other stone, ceramic material, cast iron or steel, polymer composites such as Anocast™, or other suitable material. A “split-axis” design attaches a panel stage for moving a PCB or flex circuit panel, or other suitable target, on the lower base and a tool stage on the upper base.

The upper base includes a tunnel through its lower side, that is, the side facing the lower base. The tunnel is sized to accommodate the panel stage and panels or other targets carried by the panel stage. The panel stage and the tool stage are arranged to move along axes that are orthogonal to each other, but in separate, parallel, or substantially parallel, planes. Tools attached to the tool stage are moveable along a third axis that is orthogonal to both the first and second axes.

A slot cut in the upper base opens on the top surface of the upper base and on the top portion of the tunnel, thus creating a passage through the upper base between the tunnel and the top surface of the upper base. Tools carried by the tool stage are positioned to operate through the slot and on the surfaces of targets carried by the panel stage. One or both of multiple slots and multiple tool stages may be provided in alternative embodiments. Alternative embodiments may locate tool stages at the edges of a tunnel and may not require one or more slots.

The solid, stable, and compact design of the upper and lower bases preferably creates a mechanical system with a short stiffness loop. Preferred embodiments also have natural frequencies greater than the frequencies at which the panel stage or the tool stage are driven, and natural frequencies that are greater than frequencies resulting from moving the tool orthogonally to the panel and tool stage directions. For example, one or both of a tool stage and a panel stage are preferably driven at 25 Hz, while a preferred via drilling system preferably has a natural frequency in a range of 100 Hz to 150 Hz.

Additional aspects and advantages will be apparent from the following detailed description of preferred embodiments, which proceeds with reference to the accompanying drawings.

### BRIEF DESCRIPTION OF THE DRAWINGS

FIG. 1 is an isometric schematic view of a multiple stage via drilling system, including a hypothetical stiffness loop between a tool stage and a panel stage.

FIG. 2 is an isometric view of an exemplary panel stage.

FIG. 3 is an isometric view of an exemplary tool stage and tool, showing the upper stage supporting a scan lens and upper stage drive components.

FIG. 4 is an exploded view of an exemplary tool including a laser beam focal region control subsystem.

FIGS. 5-7 are schematic plan views of alternative via drilling systems.

### DETAILED DESCRIPTION OF PREFERRED EMBODIMENTS

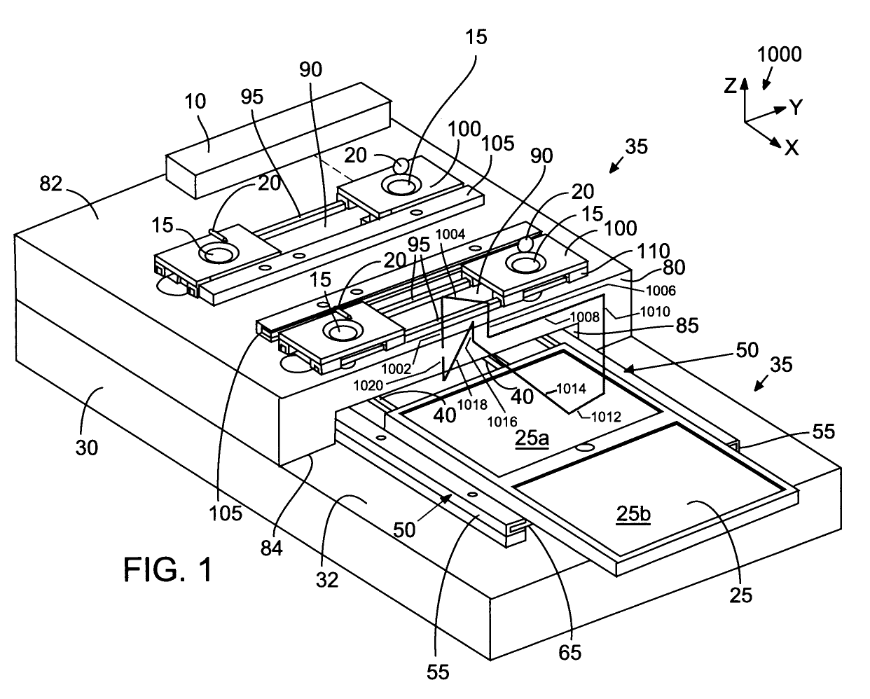

FIG. 1 shows a decoupled, multiple stage via drilling system 5, which, in a preferred embodiment, supports components of a laser processing system (partly illustrated including a laser 10, scan lenses 15 (four shown), and beam deflectors 20 (four shown)) through which a laser beam propagates for incidence on a target 25. Target 25 shows two work pieces 25a and 25b, but more or fewer work pieces may be included. Each work piece includes one or more devices to be processed, for example, printed circuit boards. Targets 25 may include printed circuit board panels, flex circuit web rolls, or other suitable targets. Alternative embodiments may support mechanical drills (not illustrated), or other suitable drilling tools or equipment, for processing targets 25 by, for example, drilling vias.

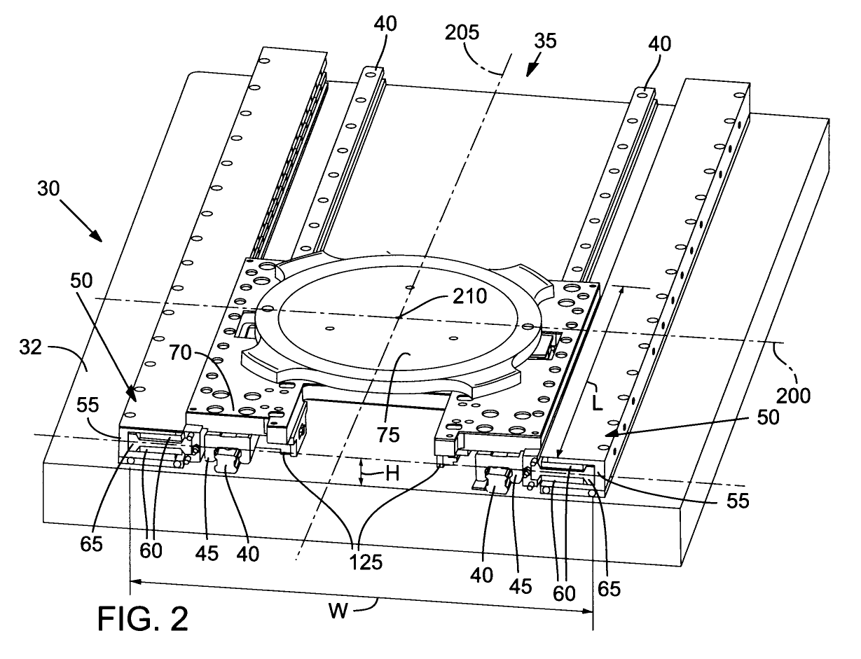

Via drilling system 5 includes a dimensionally stable lower base structure 30 made from a stone slab, preferably formed from granite or other suitable stone, or from a slab of ceramic material, cast iron, or polymer composite material such as Anocast™. Lower base structure 30 has a flat upper surface 32. An exemplary panel stage 35 (FIG. 2) is attached, or mechanically coupled, to flat upper surface 32 of lower base structure 30. First and second guide rails 40 are spaced apart and secured to flat upper surface 32 to guide movement of the moving portions of panel stage 35 (underneath the target 25) along a first or X axis of a Cartesian coordinate system 1000.

Referring to FIG. 2, two U-shaped guide blocks 45 are supported on, fit over, and slide along a corresponding rail 40 in response to an applied motive force. A motor drive for the panel stage 35 includes linear motors 50 that are mounted on flat upper surface 32 (FIG. 1) and along the length of each guide rail 40. Linear motors 50 impart the motive force to propel guide blocks 45 for sliding movement along corresponding guide rails 40. Each linear motor 50 includes a U-channel magnet track 55 that holds spaced-apart linear arrays of multiple magnets 60 arranged along the length of each guide rail 40. A forcer coil assembly 65 positioned between the linear arrays of magnets 60 is connected to the carriage 70 of a chuck 75 and constitutes the movable member of linear motor 50 that moves chuck 75. A suitable linear motor 50 is a Model MTH480, available from Aerotech, Inc., Pittsburgh, Pa.

Each rail guide 40 and guide block 45 forms a guide track assembly that is a rolling element bearing assembly. Alternative guide track assemblies include a flat air bearing or a vacuum preloaded air bearing. Use of either type of air bearing entails using portions of flat upper surface 32 as guide surfaces and attaching the guide surface or bearing face of the air bearing to carriage 70. Suitable air bearings are available from New Way Machine Components, Inc., Aston, Pa. Thus, depending on the type of guide track assembly used, surface portions of flat upper surface 32 may represent a guide rail mounting contact surface or a bearing face non-contacting guide surface. Other suitable mechanisms may be used to drive and guide chuck 75.

In a preferred embodiment, linear motors 50 drive the combined chuck 75, carriage 70, guide blocks 45 and forcer coil assemblies 65 through the center of mass of the combined assembly. An object's center of mass is a fixed point that is determined by the distribution of the masses of the particles that constitute the object. The center of mass may be considered to be a location where a uniform gravitational field acts on the object as though the mass were concentrated at the one location. The center of mass of an object may coincide with the object's centroid, or geometric center, but does not need to. The center of mass is fixed in relation to the object and may occur within the physical boundaries of the object, but may occur outside the physical boundaries of the object.

For example, each forcer coil assembly 65 has a length “L” extending along the X axis, and the center of mass for each forcer assembly 65 occurs at a point on line 200, which preferably bisects distance “L.” Preferably, the geometric center of each forcer coil assembly 65 also occurs at a point along line 200. The center of mass for each forcer assembly 65 also occurs at a distance (not illustrated) from the line 205, and a height (not illustrated) above flat upper surface 32 of base 30. Line 205 preferably represents the midline between the outer edges of forcer coil assemblies 65. The distance between the outer edges of forcer coil assemblies 65 is represented by distance “W”. In a like manner, guide blocks 45, carriage 70, and chuck 75 have centers of mass located at a point on line 200, a distance (not illustrated) from the line 205, and a height (not illustrated) above flat upper surface 32 of base 30. The size, shape, materials, and relative location of forcer coil assemblies 65, guide blocks 45, carriage 70, and chuck 75 is preferably arranged so that the center of mass of the combined forcer coil assemblies 65, guide blocks 45, carriage 70, and chuck 75 occurs at the intersection 210 of lines 200 and 205, which preferably overlies the geometric center of chuck 75. The center of mass of the combined forcer coil assemblies 65, guide blocks 45, carriage 70, and chuck 75 also preferably occurs at a height “H” above flat upper surface 32, where “H” coincides with the height of the center of mass of linear drive motors 50 above flat upper surface 32.

By aligning the center of mass of the combined forcer coil assemblies 65, guide blocks 45, carriage 70, and chuck 75 with (1) height “H,” (2) the center of mass of forcer coil assemblies 65, and (3) the center of mass and the geometric center of chuck 75, linear drive motors 50 preferably drive chuck 75, carriage 70, guide blocks 45, and forcer coil assemblies 65 through the center of mass of the combined assembly. Numerous alternate arrangements may be used to cause linear drive motors 50 to drive chuck 75, carriage 70, guide blocks 45, and forcer coil assemblies 65, or other suitable components, through the center of mass of the combined assembly.

A target 25 (FIG. 1) is aligned with and attached to chuck 75, for example by a vacuum or partial vacuum, for movement along the X axis. Preferably, the center of mass of target 25 is located at point 210 when target 25 is attached to chuck 75, and the center of mass of target 25 preferably contributes to locating the center of mass of the combination of target 25, chuck 75, carriage 70, guide blocks 45, and forcer coil assemblies 65 at the height “H”.

Driving the combination of target 25, chuck 75, carriage 70, guide blocks 45, and forcer coil assemblies 65 through the center of mass of the combined assembly helps reduce accelerations imparted to lower base structure 30 and to upper base structure 80, and preferably permits chuck 75 to be driven faster, without sacrificing accuracy of target 25 placement, than if the linear motors 50 did not drive through the center of mass. For example, linear motors 50 preferably drive panel stage 35 at 25 Hz or faster, whereas current via drilling systems may be limited to 15 Hz or slower.

Referring again to FIG. 1, a dimensionally stable upper base 80 is attached to lower base 30 by using an adhesive, mortar, or glue; or by securing in upper base 80 threaded bolts (not illustrated) that extend through apertures in lower base 30 for receiving washers and nuts; welding; or by other suitable manner. Alternatively, upper base 80 and lower base 30 are formed from a solid block of the same material by forging, casting, machining, or other suitable process. Alternatively, upper base 80 and lower base 30 are mechanically coupled together, with or without additional components between upper base 80 and lower base 30.

Upper base 80 includes a flat upper surface 82 and a flat lower surface 84. Surfaces 32, 82, and 84 are preferably mutually plane parallel to one another and conditioned to exhibit flatness and parallelism within about a ten micron tolerance. A tunnel 85 traverses through upper base 80 and is sized to straddle panel stage 35 and accommodate passage of a target 25 traveling therethrough.

Slots 90 extend in a transverse direction to the lengths of linear motors 50 and communicate flat upper surface 82 of upper base 80 with tunnel 85. Guide tracks 95 are attached, or mechanically coupled, to upper surface 82 on opposing sides of slots 90. Guide tracks 95 are portions of a guide assembly similar to the guide assemblies described above with respect to panel stage 35. The guide assemblies may alternatively include air bearings as also described above. Guide tracks 95 support one or more exemplary tool stages 100 (four shown in FIG. 1) for linear movement along a second or Y axis of Cartesian coordinate system 1000. The Y axis is orthogonal to the first axis and lies in a plane parallel to the plane containing the first axis. Like linear drive motors 50 that move chuck 75, linear drive motors 105 that move tool stages 100 are preferably connected to tool stages 100 so that the imparted drive force acts through the center of mass of each tool stage 100, the center of mass of an attached tool, or both.

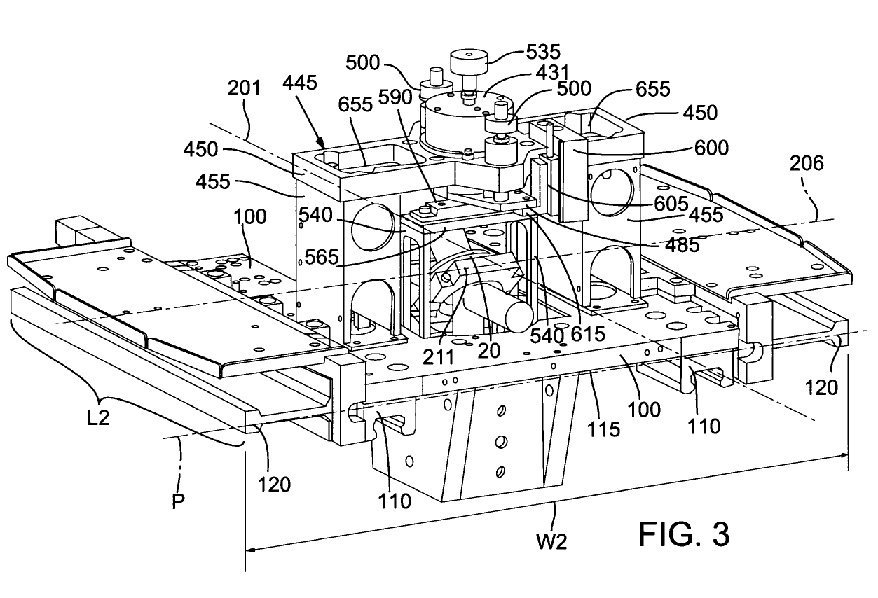

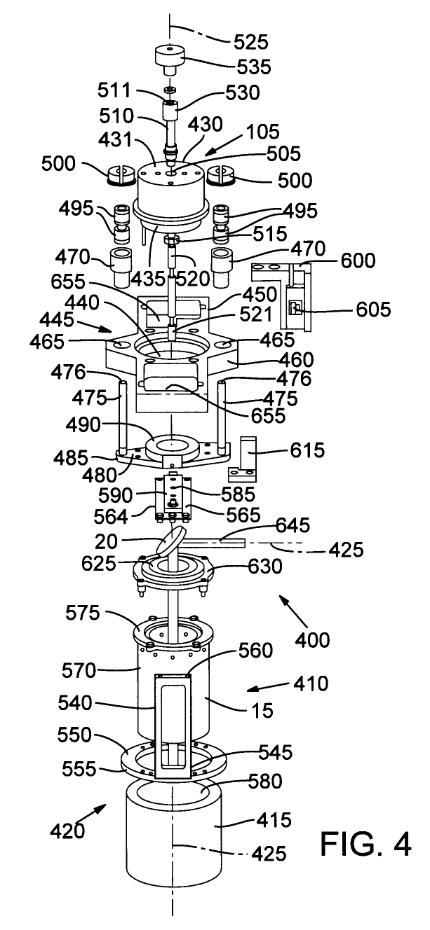

Referring to FIG. 3, a tool stage 100 preferably includes a drilling tool such as a laser beam focal control subsystem 400 (FIG. 4) that is moved by linear motors 105. Two spaced-apart guide rails 95 (FIG. 1) are preferably secured to flat upper surface 82 (FIG. 1), and U-shaped guide blocks 110 are preferably supported on a bottom surface 115 of tool stage 100. Each one of guide blocks 110 preferably fits over and slides along a corresponding one of rails 95 in response to an applied motive force. A motor drive for tool stage 100 preferably includes a linear motor 105 (FIG. 1) that is mounted on flat upper surface 82 and along the length of a guide rail 95. Linear motor 105 imparts the motive force to propel its corresponding guide block 110 for sliding movement along its corresponding guide rail 95. Each linear motor 105 includes a U-channel magnet track (not illustrated) that holds spaced-apart linear arrays of multiple magnets (not illustrated) arranged along the length of guide rail 95. The arrangement of linear motors 105 may be similar to the arrangement of linear motors 50 (FIG. 2). A forcer coil assembly 120 positioned between the linear arrays of magnets is connected to tool stage 100 and constitutes the movable member of linear motor 105 that moves tool stage 100. A suitable linear motor 105 is a Model MTH480, available from Aerotech, Inc., Pittsburgh, Pa.

A pair of encoder heads 125 (FIG. 2) is preferably secured to bottom surface 115 of tool stage 100 and positioned adjacent different ones of guide blocks 110. Position sensors that measure yaw angle and distance traveled of tool stage 100 are preferably included. Placement of the position sensors in proximity to guide rails 95, guide blocks 110, and linear motors 105 driving each tool stage 100 ensures efficient, closed-loop feedback control with minimal resonance effects. If included, a pair of stop members (not illustrated) limit the travel distance of guide blocks 110 in response to limit switches included in encoder heads 125 that are tripped by a magnet (not shown) attached to upper base 80. If included, a pair of dashpots (not illustrated) dampen and stop the motion of tool stage 100 to prevent it from over travel movement off of guide rails 95.

FIG. 4 shows in greater detail the components of control subsystem 400 and its mounting on tool stage 100. Control subsystem 400 includes a lens forcer assembly 405 that is coupled by a yoke assembly 410 to scan lens 15 contained in the interior of an air bushing 415 of air bearing assembly 420. A suitable air bushing is Part No. S307501, available from New Way Machine Components, Inc., Aston, Pa. Lens forcer assembly 405, which is preferably a voice coil actuator, imparts by way of yoke assembly 410 a motive force that moves scan lens 15 and thereby the focal region of the laser beam to selected positions along beam axis 425. A preferred voice coil device 405 is an Actuator No. LA 28-22-006 Z, available from BEI Kimco Magnetics, Vista, Calif.

Voice coil actuator 405 includes a generally cylindrical housing 430 and an annular coil 435 formed of a magnetic core around which copper wire is wound. Cylindrical housing 430 and annular coil 435 are coaxially aligned, and annular coil 435 moves axially in and out of housing 430 in response to control signals (not shown) applied to lens forcer assembly 405.

Annular coil 435 extends through a generally circular opening 440 in a voice coil bridge 445 having opposite side members 450 that rest on uprights 455 (FIG. 3) mounted on tool stage 100 to provide support for laser beam focal region control subsystem 400. Voice coil bridge 445 includes in each of two opposite side projections 460 a hole 465 containing a tubular housing 470 through which passes a rod 475 extending from an upper surface 480 of a guiding mount 485. Each rod 475 has a free end 476. Guiding mount 485 has on its upper surface 480 an annular pedestal 490 on which annular coil 435 rests. Two stacked, axially aligned linear ball bushings 495 fit in tubular housing 470 contained in each hole 465 of side projections 460 of voice coil bridge 445. Free ends 476 of rods 475 passing through ball bushings 495 are capped by rod clamps 500 to provide a hard stop of lower travel limit of annular coil 435 along beam axis 425.

Housing 430 has a circular opening 505 that is positioned in coaxial alignment with the center of annular coil 435, opening 440 of voice coil bridge 445, and the center of annular pedestal 490 of guiding mount 485. A hollow steel shaft 510 extends through opening 505 of housing 430, and a hexagonal nut 515 connects in axial alignment hollow steel shaft 510 and a flexible tubular steel member 520, which is coupled to yoke assembly 410 as further described below. Hexagonal nut 515 is positioned in contact with a lower surface of annular coil 435 to drive flexible steel member 520 along a drive or Z-axis 525 (see FIG. 1 for Z-axis orientation) in response to the in-and-out axial movement of annular coil 435. Hollow steel shaft 510 passes through the center and along the axis of a coil spring 530, which is confined between a top surface 431 of housing 430 and a cylindrical spring retainer 535 fixed at a free end 511 of hollow steel shaft 510. Coil spring 530 biases annular coil 435 to a mid-point of its stroke along Z-axis 525 in the absence of a control signal applied to voice coil actuator 405.

Yoke assembly 410 includes opposed yoke side plates 540 (only one shown) secured at one end 545 to a surface 550 of a yoke ring 555 and at the other end 560 to a multilevel rectangular yoke mount 565. Scan lens 15 formed with a cylindrical periphery 570 and having an annular top flange 575 fits in yoke assembly 410 so that top flange 575 rests on surface 550 of yoke ring 555. Scan lens 15 contained in the interior of air bushing 415 forms the inner race of air bearing assembly 420, and an inner surface 580 of air bushing 415 forms the outer race of air bearing assembly 420. The implementation of air bearing assembly 420 increases the rigidity of scan lens 15 in the X-Y plane but allows scan lens 15 to move along the Z-axis in a very smooth, controlled manner.

Flexible steel member 520 has a free end 521 that fits in a recess 585 in an upper surface 590 of yoke mount 565 to move it along Z-axis 525 and thereby move scan lens 15 along beam axis 425. An encoder head mount 600 holding an encoder 605 and attached to voice coil bridge 445 cooperates with an encoder body mount 615 holding an encoder scale and attached to guiding mount 485 to measure, using light diffraction principles, the displacement of guiding mount 485 relative to voice coil bridge 445 in response to the movement of annular coil 435. Because flexible tubular steel member 520 is attached to annular coil 435, the displacement measured represents the position of scan lens 15 along beam axis 425.

A quarter-waveplate 625 secured in place on a mounting ring 630 is positioned between a lower surface 564 of rectangular yoke mount 565 and top flange 575 of scan lens 15. A beam deflection device 20, such as a piezoelectric fast steering mirror, attached to tool stage 100 (FIG. 3) is positioned between rectangular yoke mount 565 and quarter-waveplate 625. Fast steering mirror 20 receives an incoming laser beam 645 propagating along beam axis 425 and directs laser beam 645 through quarter-waveplate 625 and scan lens 15. Quarter-waveplate 625 imparts circular polarization to the incoming linearly polarized laser beam, and fast steering mirror 20 directs the circularly polarized laser beam for incidence on selected locations of the work piece of a target 25 supported on panel stage 35. One or both of scan lens 15 and steering mirror 20 are preferably controlled for micro-adjustment in the X-Y plane, for example, with a range of movement of 18 mm to 20 mm, regarding where the laser intersects target 25. When fast steering mirror 20 is in its neutral position, Z-axis 525, beam axis 425, and the propagation path of laser beam 645 are collinear. When fast steering mirror 20 is in operation, the propagation path of laser beam 645 is generally aligned with beam axis 425.

Flexible steel member 520 is rigid in the Z-axis direction but is compliant in the X-Y plane. These properties of flexible steel member 520 enable it to function as a buffer, isolating the guiding action of air bearing assembly 420 containing scan lens 15 from the guiding action of lens forcer assembly 405 that moves scan lens 15.

Lens forcer assembly 405 and air bearing assembly 420 have centers of mass and are positioned along Z-axis 525. Voice coil bridge 445 of lens forcer assembly 405 has two depressions 655, the depths and cross sectional areas of which can be sized to achieve the axial alignment of the two centers of mass. Such center of mass alignment eliminates moment arms in control system 400 and thereby helps reduce propensity of low resonant frequency vibrations present in prior art cantilever beam designs.

Tool stages 100 each support a drilling tool, for example, a laser beam focal region control subsystem 400, or a drill (not illustrated). Laser beam focal region control subsystem 400 directs a laser beam through slots 90 and onto a surface of target 25. The center line of the scan lens 15, or other suitable tool such as a drill, is preferably coincident with the center of mass and with the center of stiffness of tool stage 100. Thus, if tool stage 100 rotates in the X-Y plane, such rotation preferably does not affect the position of a laser beam directed through scan lens 15, or tool bit, onto target 25.

Aligning the center of mass and the center of stiffness of tool stages 100 with the center of mass of the tool carried by each tool stage 100 helps linear motors 105 drive tool stages 100 faster than they could be driven had the centers of mass and stiffness not been aligned, without sacrificing accuracy of tool placement. For example, linear motors 105 preferably drive tool stages 100 at 25 Hz or faster, whereas current via drilling systems may be limited to 15 Hz or slower.

Referring to FIG. 3, line 206 preferably bisects distance “L2,” which is the length of forcer coil assemblies 120. Preferably, the geometric center of each forcer coil assembly 120 also occurs at a point along line 206. The center of mass for each forcer assembly 120 also occurs at a distance (not illustrated) from the line 201. Line 201 preferably represents the midline between the outer edges of forcer coil assemblies 120. The distance between the outer edges of forcer coil assemblies 120 is represented by distance “W2”. Preferably, the center of mass and center of stiffness of the combined tool stage 100 and tool, such as laser beam focal region control subsystem 400, coincide in the X-Y plane with point 211, and are located in a plane “P” that bisects forcer coil assemblies 120. Point 211 preferably coincides with the central Z-axis 525 of laser beam focal control subsystem 400 (FIG. 4).

Preferably, the laser 10 and related system operational components (not illustrated) are supported on the same upper base 80 that supports tool stages 100. Coupling the laser system, or other suitable operational components, on upper base 80 that also carries tool stages 100 preferably reduces parasitic movement between the tool operational components and tool stages 100. For example, current via drilling systems may support tool operational components, such as a laser system, on a structure that is separate from the structure that supports the tool stage. In such an arrangement, parasitic movement may occur between the tool operational components and the tool stage because the support structure for each may move independently. By coupling the tool operational components and tool stages 100 on the same support structure (i.e., upper base 80), such independent movement is reduced or may be eliminated, thus reducing parasitic movement between the tool operational components and tool stages 100.

The guided motions of chuck 75 and tool stages 100 move scan lenses 15 relative to processing locations on a surface of target 25 held by chuck 75. If included, sensors are positioned adjacent different ones of guide blocks 45 and 110 and preferably include position sensors 125 that measure yaw angle and distance traveled of chuck 75 and tool stages 100. Placing the position sensors in proximity to the guide rails 40 and 95, guide blocks 45 and 110, and linear motors 50 and 105 driving chuck 75 and tool stages 100 preferably provides efficient, closed-loop feedback control with minimal resonance effects.

Multiple tool stages 100 are preferably provided, thereby permitting two or more tools to perform operations, such as via drilling, on one or more locations on a target 25. For example, as illustrated in FIG. 1, target 25 preferably includes two work pieces 25a and 25b. When panel stage 35 drives target 25, the tools carried by two tool stages 100 perform operations on the work piece 25b, and the tools carried by the other two tool stages 100 perform operations on the work piece 25a. Tool stages 100 and associated tools may be controlled to perform the same operations, at the same or at different times, or may be controlled to perform different operations, at the same or at different times. Providing multiple tool stages 100 and associated tools preferably provides a range of flexibility for processing targets 25.

Embodiments of via drilling systems, for example, as illustrated in FIG. 1, or other suitable embodiments, preferably increase target 25 processing in terms of targets 25 processed per hour per square foot of floor space. The relatively high stiffness resulting from mechanical stiffness and short stiffness loops of the described, and other suitable, embodiments preferably permit panel stage 35, and tool stages 100 to be driven faster than current via drilling systems are driven, without sacrificing accuracy of target or tool placement.

Mechanical stiffness is generally the resistance of a component, or part, against deformation resulting from a force. A stiffness loop generally refers to the distance a force must travel through a device between a tool and a target, where moving the tool or the target may cause vibrations at the target or the tool, respectively. In other words, the stiffness loop is the effective length of connecting structures that react to motion forces, support components creating motion forces, or both, that is included between a tool and a target.

A hypothetical stiffness loop is illustrated in FIG. 1. A force line 1002 through the center of stiffness of a tool stage 100 (for example, when tool stage 100 is located at the center of slot 90 (not illustrated)) turns 90 degrees along a tool stage neutral axis located in the plane defined by lines 201 and 206 (FIG. 3). Line 1004 runs along the tool stage neutral axis until line 1004 intersects guide track 95. Another 90 degree turn is made and line 1006 runs through guide track 95 to a neutral axis for base 80. After another 90 degree turn, line 1008 runs along the neutral axis for base 80 until reaching a neutral axis between base 80 and base 30. Another 90 degree turn is made, and line 1010 runs along the neutral axis between base 80 and base 30 until reaching a neutral axis for base 30, for example, located within base 30. After a 90 degree turn, line 1012 runs along the neutral axis for base 30 until reaching guide track 40. A 90 degree turn brings line 1014 under guide track 40 until reaching the midpoint of guide track 40. Another 90 degree turn brings line 1016 up through guide track 40 until reaching a plane defined by lines 200 and 205 (FIG. 2). After a 90 degree turn, line 1018 runs along a neutral axis for panel stage 35 until reaching a center of action of panel stage 35, in other words, the intersection 210 of lines 200 and 205 when line 205 is located at the midpoint of linear motors 50. Another 90 degree turn and the final line 1020 of the stiffness loop runs up through the center of action of panel stage 35.

As best viewed in FIG. 1, the length of the stiffness loop is altered with movement of tool stage 100. Specifically, as tool stage 100 moves away from the center of slot 90, the length of the stiffness loop decreases. The length of a stiffness loop for a currently available via drilling apparatus may be approximately 2,260 mm. In comparison, embodiments of the via drilling system described herein preferably have a stiffness loop in a range between about 800 mm and about 1,500 mm, and preferably about 1,000 mm. Just as the shorter of two cantilever beams of identical cross section and material has a greater resistance to movement resulting from an applied force, panel stage 35 and tool stages 100 of described embodiments preferably have a greater resistance to vibration resulting from the force of driving tool stages 100 and panel stage 35, respectively, than prior art via drilling systems do.

Another factor that influences stiffness is the mass and rigidity of the components included in the stiffness loop. In the example illustrated in FIG. 1, each of base 30 and base 80 preferably have a mass that is relatively greater than panel stage 35, tool stages 100, or both. Alternatively, base 30 and base 80 together have a mass that is relatively greater than panel stage 35, tool stages 100, or both. And, base 30 and base 80 are preferably made from rigid, mechanically stiff materials as described above.

Providing multiple tool stages 100 and associated tools to operate on one target 25 (instead of one tool per target as is common in current via drilling systems) preferably increases target 25 processing speeds. Additionally, the compact size of described, and other suitable, embodiments preferably require less floor space than current via drilling systems. Faster stage speeds, increased mechanical stiffness, multiple tools operating on a single target, and a compact size, singularly or in any combination, helps make the described, and other suitable embodiments, more efficient in terms of targets 25 processed per hour per square foot of floor space than current via drilling systems.

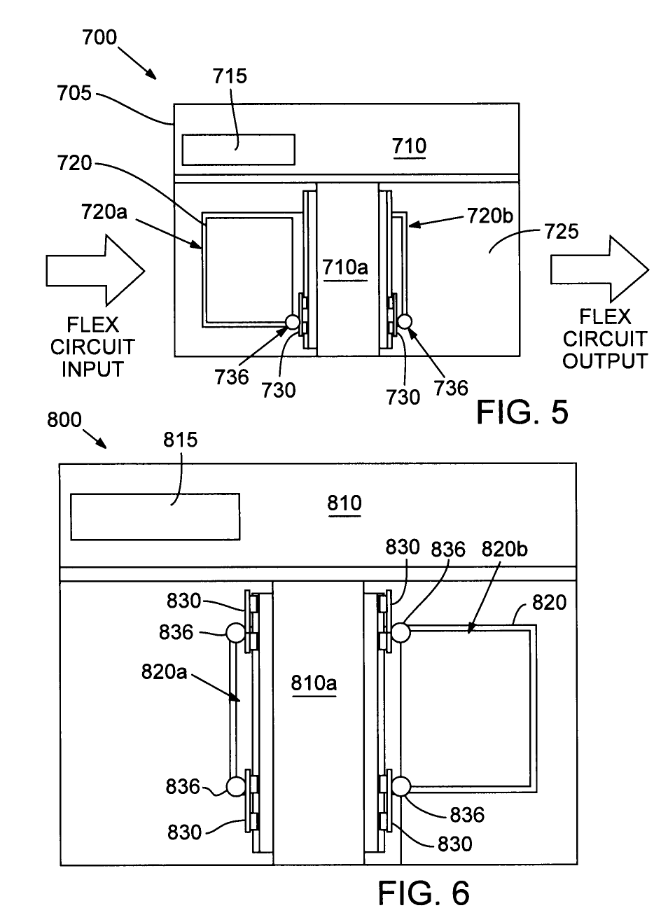

A variety of configurations may result in a via drilling system with a short stiffness loop and a compact foot print. For example, FIGS. 5-7 illustrate schematic diagrams for various layouts for a via drilling system. FIG. 5 illustrates a via drilling system 700 including a laser and optics bay 705 supported by upper base 710. A laser system 715 is preferably located in the laser and optics bay 705. A portion, 710a, of upper base 710 straddles the panel stage (not illustrated) and the target 720. The panel stage is supported on the lower base 725. Tool stages 735 and their associated tools 736 are supported on the portion 710a of the upper base 710. In operation, a target 720 is loaded onto the panel stage (not illustrated). The panel stage moves the target 720 in the direction of the flex circuit input and output arrows. As the panel stage moves target 720 under upper base portion 710a, tool stages 735 move transverse to the flex circuit input and output arrows to move tools 736 across target 720. Preferably, one tool 736 performs operations, such as via drilling, on work piece 720a, while the other tool 736 performs operations on work piece 720b. Tools 736 may operate sequentially, substantially simultaneously, or both. Target 720 is preferably unloaded from the panel stage near the flex circuit output arrow once processing is complete. FIG. 6 illustrates a similar via drilling system 800, but with multiple tool stages 830 and associated tools 836 to operate on target 820.

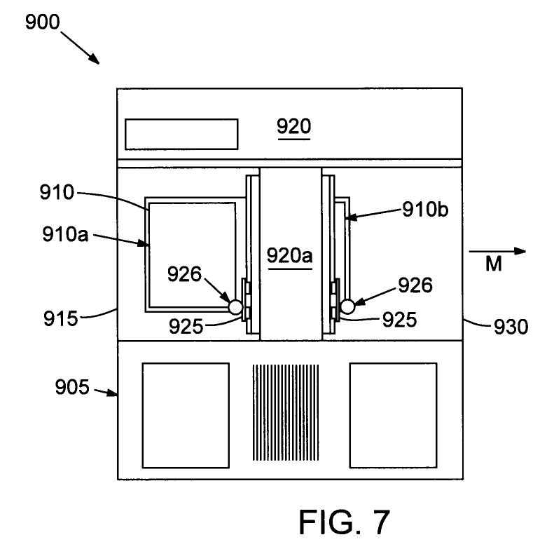

FIG. 7 illustrates a via drilling system 900 that includes an autoloader 905 for automatically loading a target 910 to be processed and for automatically unloading target 910 when processing is finished, then loading another target 910 for processing. For example, autoloader 905 loads a target 910 onto a panel stage (underneath target 910 and not illustrated) proximate the front 915 of via drilling system 900. Target 910 includes one or more work pieces 910a, 910b, etc. Once target 910 is loaded onto the panel stage by autoloader 905, the panel stage moves target 910 in the direction of arrow “M”. As the panel stage moves target 910 under upper base portion 920a, tool stages 925 move transverse to arrow “M” to move tools 926 across target 910. Preferably, one tool 926 performs operations, such as via drilling, on work piece 910a, while the other tool 926 performs operations on work piece 910b. Tools 926 may operate sequentially, substantially simultaneously, or both. When processing is complete, autoloader 905 preferably unloads target 910 proximate the back 930 of via drilling system 900, then returns the panel stage to the front 915 of via drilling system 900. Autoloader 905 then loads another target 910 onto the panel stage for processing.

It will be obvious to those having skill in the art that many changes may be made to the details of the above-described embodiments without departing from the underlying principles of the invention. The scope of the present invention should, therefore, be determined only by the following claims.

1. A method of reducing, to within an operational tolerance, occurrences of drilling tool positioning errors produced by a drilling system operating at high throughput rates, the drilling system including a target support mechanism and a tool support mechanism that contribute to positioning tools over target locations, comprising:
providing as the target support mechanism a device having a drive mechanism and a moveable portion driven by the drive mechanism, the moveable portion constructed to hold a target, and the moveable portion having a center of mass and a center of stiffness;
mounting the target support mechanism on a first dimensionally stable base structure;
providing as the tool support mechanism multiple drilling tool positioning devices, each drilling tool positioning device having a drive mechanism and a moveable portion driven by the drive mechanism, each moveable portion having a center of mass and a center of stiffness;
mounting the tool support mechanism on a second dimensionally stable base structure;
mechanically coupling the second base structure to the first base structure; and
mounting multiple drilling tools for carriage by the tool support mechanism, each of the multiple drilling tools including a center line that is substantially aligned with the centers of mass and stiffness of the drilling tool positioning device that carries each drilling tool, thereby to substantially eliminate positioning errors resulting from spurious rotational movement of the drilling tool positioning devices as they accelerate or decelerate during movement to position each tool over target locations.

2. A method according to claim 1, wherein the target support mechanism includes a panel stage; and the tool support mechanism includes multiple tool stages.

3. A method according to claim 1, wherein the target support moveable portion centers of mass and of stiffness are aligned, and the target support drive mechanism drives the target support moveable portion through the centers of mass and of stiffness; and
each drilling tool positioning device moveable portion centers of mass and of stiffness are aligned, and the drilling tool positioning device drive mechanism drives each drilling tool positioning device moveable portion through its centers of mass and of stiffness; thereby
to reduce, to within an operational tolerance, occurrences of tool positioning errors produced by vibrations caused by accelerating or decelerating the target support moveable portion and each drilling tool positioning device moveable portion.

4. A method according to claim 1, wherein each drilling tool includes a laser beam focal control subsystem and each laser beam focal control subsystem includes an objective lens where the center of the objective lens is aligned with the centerline of the laser beam focal control subsystem.

5. A method according to claim 1, further comprising:
providing a slot through the second dimensionally stable base such that at least one drilling tool is operational through the slot to perform drilling operations on a target.

6. A method according to claim 1, further comprising:
providing drilling tool operational components; and
mounting the drilling tool operational components on the second dimensionally stable base structure.

7. A method according to claim 1, wherein coupling the second base structure to the first base structure includes providing a relatively short stiffness loop.

8. A method according to claim 7, wherein the relatively short stiffness loop is in a range of between about 800 mm and about 1500 mm.

9. A system for processing a target, comprising:
a first dimensionally stable base structure;
a panel stage mechanically coupled to the first base structure, the panel stage operable to carry a target along a first axis of a Cartesian coordinate system;
a second dimensionally stable base structure mechanically coupled to the first base structure, the second base structure including a tunnel sized to accommodate the panel stage and one target;
a tool stage mechanically coupled to the second base structure, the tool stage operable to move a tool along a second axis of the Cartesian coordinate system where the first and second axes of the Cartesian coordinate system lie in a plane substantially parallel to the upper surface of the second base structure; and
a tool carried by the tool stage and operable to process the target carried by the panel stage.

10. A system for processing a target according to claim 9, wherein the natural frequency of the attached first dimensionally stable base structure and the second dimensionally stable base structure is in the range of 100 Hz to 150 Hz.

11. A system for processing a target according to claim 9, further comprising:
a first slot through the second base structure, the first slot communicating an upper surface of the second base structure with the tunnel; wherein
the tool is operable through the first slot to process the target.

12. A system for processing a target according to claim 11, further comprising:
a second slot through the second base structure, the second slot communicating an upper surface of the second base structure with the tunnel;
a second tool stage attached to the second base structure, the second tool stage operable to move a second tool along the second axis of the Cartesian coordinate system;
a third tool stage attached to the second base structure, the third tool stage operable to move a third tool along the second axis of the Cartesian coordinate system; and
a fourth tool stage attached to the second base structure, the fourth tool stage operable to move a fourth tool along the second axis of the Cartesian coordinate system; wherein
the first tool and the second tool are operable through the first slot to process the target; and
the third tool and the fourth tool are operable through the second slot to process the target.

13. A system for processing a target according to claim 9, further comprising:
a tool sub-stage carried by the tool stage, the tool sub-stage operable to move the tool along the third axis of the Cartesian coordinate system.

14. A system for processing a target according to claim 9, wherein the first base structure and the second base structure are formed from a solid block of material.

15. A system for processing a target according to claim 9, further comprising operational components for the tool, the operational components supported by the second base structure.

16. A system for processing a target according to claim 9, wherein the tool includes a laser beam directing assembly with an objective lens operable to direct a laser beam propagating along a laser beam propagation path onto a target, and the components include a laser generator.

17. A system for processing a target according to claim 16, wherein the objective lens includes a center line, and the tool stage includes a center of mass; and
the objective lens center line is aligned with the center of mass of the tool stage.

18. A system for processing a target according to claim 17, wherein:
the panel stage includes a motor and a moveable portion having a center of mass, the panel stage motor driving the moveable portion through the center of mass; and
the tool stage includes a motor, the tool stage motor driving the tool stage through the center of mass.

19. A system for processing a target according to claim 18, wherein:
the panel stage includes a center of stiffness aligned with the center of mass; and
the tool stage includes a center of stiffness aligned with the center of mass.
